(19) United States
(12) Patent Application Publication
(10) Pub. No.: US 2003/0167743 A1
(43) Pub. Date: Sep. 11, 2003

(54) Device used to purify air and keep cleanly the duct of hot air system or central air exchanger

(76) Inventor: Jean-Pierre Blais, St-Jean Chrysostome (CA)

Correspondence Address: Mr. Jean-Pierre Blais, 1028 Carre Beausoleil, St-Jean Chrysostome, QC, G6Z 1P9, CA

(21) Appl. No.: 10/091,142

(22) Filed: Mar. 5, 2002

(51) Int. Cl. B01D 46/00

(52) U.S. Cl. 55/502; 55/521

(57) ABSTRACT

The present disclosure relates to a device used to purify air and keep cleanly the duct of hot air system or central air exchanger, is made up of a filter having the shape of a cone, which can be installed into the round, square or rectangular duct inlet inhaling air of the indoor from the house, and which a fixing means is adapted to the shape of round, square or rectangular duct inlet.

### BACKGROUND OF THE INVENTION

1) Field of the Invention

The present invention relates to a device used to purify air and keep cleanly the duct of hot air system or central air exchanger.

2) Description of the Related Art

A search of prior art records has unveiled the following United States patents:

1. U.S. Pat. No. 4,804,392 issued in 1989 to Spengler;

2. U.S. Pat. No. 4,552,657 issued in 1985 to Ogawa;

3. U.S. Pat. No. 4,666,531 issued in 1987 to Minard.

The patents to Spengler, Ogawa and Minard are probably the most relevant. As can be seen, the patents do not show a device used to purify air and keep cleanly the duct of hot air system or central air exchanger, which is installed into the duct inlet inhaling air of the indoor from the house.

### SUMMARY OF THE INVENTION

The gist of the invention is therefore to provide a device adapted for any hot air system or central air exchanger allowing to purify air and keep cleanly the duct.

The present invention shows a device having the shape of a cone, which can be installed into the square, rectangular or round duct inlet inhaling air of the indoor from the house, and which a fixing means is adapted to the shape of round, square or rectangular duct inlet.

### BRIEF DESCRIPTION OF THE SEVERAL VIEWS OF THE DRAWING(S):

FIG. 1 is a perspective view of device having the shape of cone installed into the round duct inlet inhaling air of the indoor from the house, and which a fixing means is adapted to the shape of round duct inlet.

FIG. 2 is a perspective exploded view of device having the shape of cone installed into the round duct inlet inhaling air of the indoor from the house, and which the fixing means is adapted to the shape of round duct inlet.

FIG. 3 is a perspective view of device having the shape of cone installed into the square duct inlet inhaling air of the indoor from the house, and which a fixing means is adapted to the shape of square duct inlet.

FIG. 4 is a perspective exploded view of device having the shape of cone installed into the square duct inlet inhaling air of the indoor from the house, and which the fixing means is adapted to the shape of square duct inlet.

FIG. 5 is a perspective view of device having the shape of cone installed into the rectangular duct inlet inhaling air of the indoor from the house, and which a fixing means is adapted to the shape of rectangular duct inlet.

FIG. 6 is a perspective exploded view of device having the shape of cone installed into the rectangular duct inlet inhaling air of the indoor from the house, and which the fixing means is adapted to the shape of rectangular duct inlet.

### DETAILED DESCRIPTION OF THE INVENTION

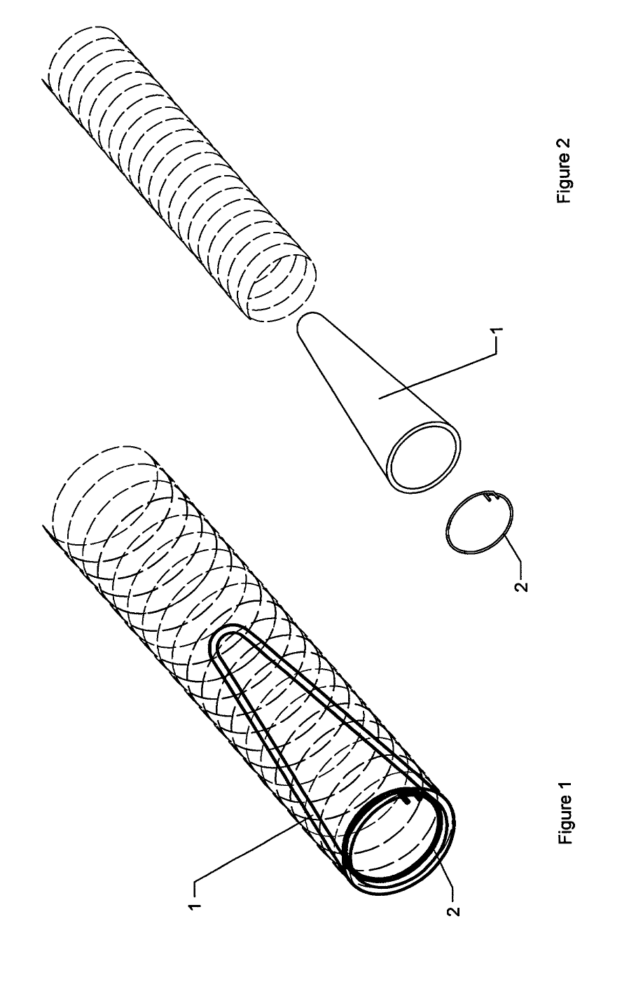

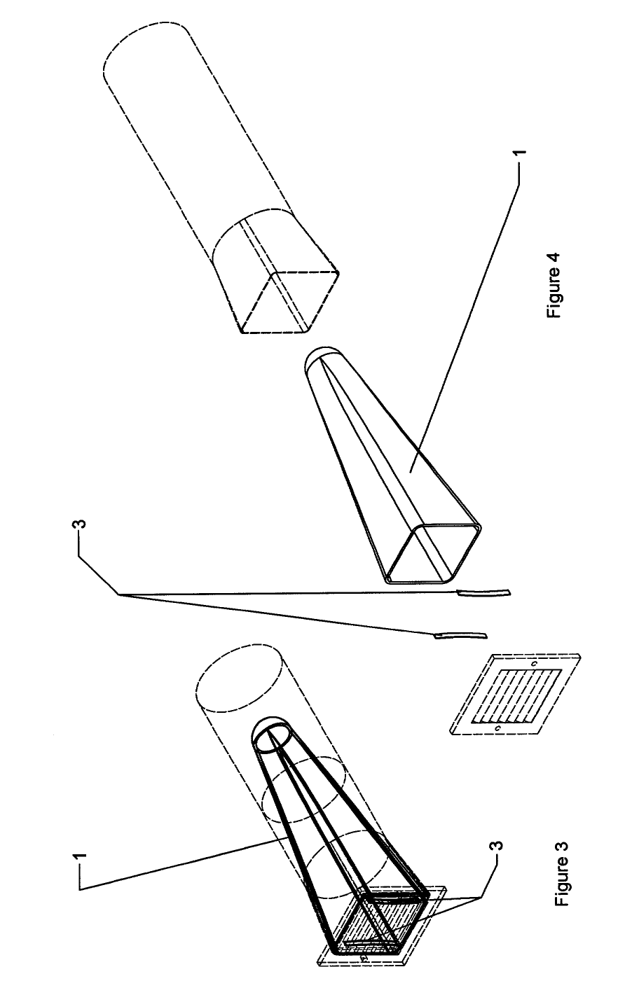

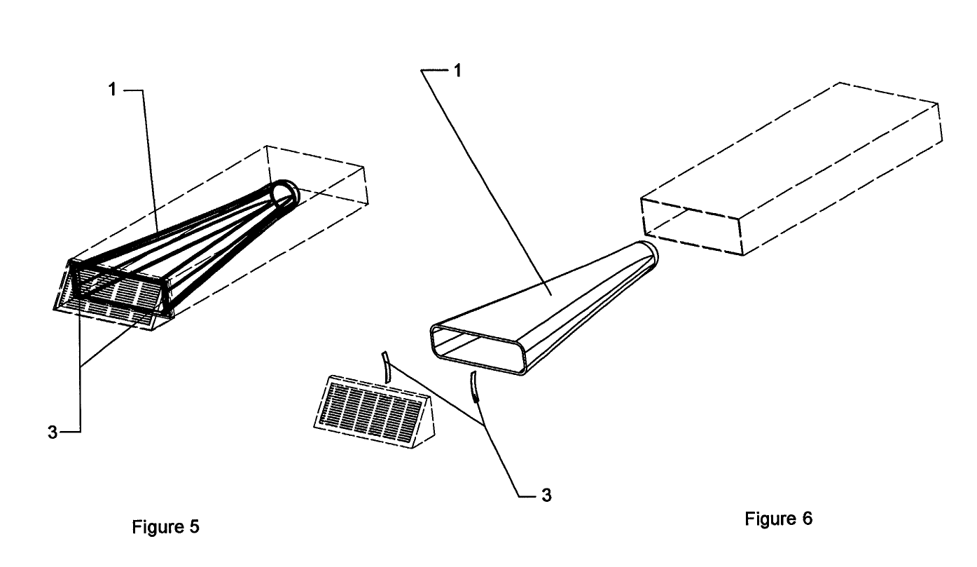

As shown in FIGS. 1, 2, 3, 4, 5 and 6 a device used to purify air and keep cleanly the duct of hot air system or central air exchanger, is made up of a filter (1) having the shape of a cone, which can be installed into the square, rectangular or round duct inlet inhaling air of the indoor from the house, and which a fixing means is adapted to the shape of round, square or rectangular duct inlet. As shown in FIGS. 1 and 2, the filter (1) is installed into the round duct inlet inhaling air of the indoor from the house, and which a fixing means (2) is adapted to the shape of round duct inlet. As shown in FIGS. 3 and 4, the filter (1) is installed into the square duct inlet inhaling air of the indoor from the house, and which a fixing means (3) is adapted to the shape of square duct inlet. As shown in FIGS. 5 and 6, the filter (1) is installed into the rectangular duct inlet inhaling air of the indoor from the house, and which the fixing means (3) is adapted to the shape of rectangular duct inlet.

The embodiments of the invention for which an exclusive property or privilege is claimed, are defined as follows:

1. A device used to purify air and keep cleanly the duct of hot air system or central air exchanger, said device comprises a filter having the shape of a cone, wherein said filter can be installed into the round, square or rectangular duct inlet inhaling air of the indoor from the house, and which a fixing means is adapted to the shape of said round, square or rectangular duct inlet.
